(19) United States
(12) Patent Application Publication
(10) Pub. No.: US 2023/0252912 A1
(43) Pub. Date: Aug. 10, 2023

(54) SIMULATION DEVICES, SYSTEMS, AND ASSOCIATED METHODS WITH AIR TRAPPING FOR ASTHMA SIMULATION

(71) Applicant: GAUMARD SCIENTIFIC COMPANY, INC., Miami, FL (US)

(72) Inventors: Miguel Carvajal, Miami Springs, FL (US); Alberto Rodriguez, Miami, FL (US)

(21) Appl. No.: 18/153,725

(22) Filed: Jan. 12, 2023

Related U.S. Application Data
(60) Provisional application No. 63/266,815, filed on Jan. 14, 2022.

(51) Int. Cl. G09B 23/32

(52) U.S. Cl. CPC G09B 23/32

(57) ABSTRACT

The present disclosure provides interactive education systems, apparatus, components, and methods for teaching patient care. In some instances, devices, systems, and associated methods include air trapping techniques for asthma simulation. In some aspects of the present disclosure, a system comprises: a patient simulator having a simulated body portion; and an asthma simulation module positioned within the simulated body portion, the asthma simulation module including: a first simulated lung; an adjustable valve along a first air path between a simulated trachea and the first simulated lung; and an air trapping module along a second air path between the simulated trachea and the first simulated lung.

### CROSS-REFERENCE TO RELATED APPLICATIONS

The present application claims priority to and the benefit of U.S. Provisional Application No. 63/266,815, filed Jan. 14, 2022, which is hereby incorporated by reference in its entirety.

### INTRODUCTION

The present disclosure relates generally to interactive education systems for teaching patient care. While it is desirable to train medical personnel in patient care protocols before allowing contact with real patients, textbooks and flash cards lack the important benefits to students that can be attained from hands-on practice. On the other hand, allowing inexperienced students to perform medical procedures on actual patients that would allow for the hands-on practice cannot be considered a viable alternative because of the inherent risk to the patient. Because of these factors patient care education has often been taught using medical instruments to perform patient care activity on a simulator, such as a manikin. Examples of such simulators include those disclosed in U.S. Pat. Application No. 11/952,559 (Publication No. 20080138778), U.S. Pat. Application No. 11/952,606 (Publication No. 20080131855), U.S. Pat. Application No. 11/952,636 (Publication No. 20080138779), U.S. Pat. Application No. 11/952,669 (Publication No. 20090148822), U.S. Pat. Application No. 11/952,698 (Publication No. 20080138780), U.S. Pat. No. 7,114,954, U.S. Pat. No. 6,758,676, U.S. Pat. No. 6,503,087, U.S. Pat. No. 6,527,558, U.S. Pat. No. 6,443,735, U.S. Pat. No. 6,193,519, and U.S. Pat. No. 5,853,292, each herein incorporated by reference in its entirety.

While these simulators have been adequate in many respects, they have not been adequate in all respects. Therefore, what is needed is an interactive education system for use in conducting patient care training sessions that is even more realistic and/or includes additional simulated features.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure provides interactive education systems, apparatus, components, and methods for teaching patient care. In some aspects of the present disclosure, a system for teaching patient care is provided. The system may include a patient simulator with a patient body comprised of one or more simulated body portions. The one or more simulated body portions may include a torso, neck, and/or head. An asthma simulation module may be positioned within the simulated body portion. The asthma simulation module may include a first simulated lung, an adjustable valve along a first air path between a simulated trachea and the first simulated lung, and an air trapping module along a second air path between the simulated trachea and the first simulated lung. In some instances, the air trapping module may be configured to move between a first configuration and a second configuration. In the first configuration, the air trapping module may allow air flow along the first air path from the simulated trachea to the first simulated lung and/or prevent air flow along the first air path from the cavity of the air trapping module to the simulated trachea. In the second configuration, the air trapping module may prevent air flow along the first air path from a cavity of the air trapping module to the simulated trachea and/or prevent air flow along the first air path from the simulated trachea to the first simulated lung.

In some aspects, the air trapping module comprises a housing having a cavity, a first port in communication with the cavity, and a second port in communication with the cavity. The air trapping module may also include a flapper coupled to the housing. The flapper may be configured to allow air flow along the first air path from the simulated trachea to the first simulated lung and prevent air flow along the first air path from the cavity to the simulated trachea when the air trapping module is in the first configuration. In some instances, the air trapping module further comprises a bellow positioned within the housing. The bellow may be movable between a deflated position associated with the first configuration and an inflated position associated with the second configuration. In some aspects, the system further comprises an air supply and at least one valve in communication with the air supply and the bellow. The at least one valve may be configured to connect the air supply to the bellow and connect the bellow to atmosphere. The air supply may include a compressor, compressed gas/air canister, and/or other source of gas/air. The at least one valve may comprise a single valve configured to connect the air supply to the bellow in a first position and connect the bellow to atmosphere in a second position. The at least one valve may comprise a first valve for connecting the air supply to the bellow and a second valve for connecting the bellow to atmosphere. The system may also include at least one processor in communication with the air supply and the at least one valve. The at least one processor may be configured to control the at least one valve to selectively move the bellow between the deflated position and the inflated position.

In some instances, the adjustable valve is configured to control an air resistance of the first air path between the simulated trachea and the first simulated lung. In this regard, the adjustable valve may be configured to symmetrically and/or asymmetrically control the air resistance of the first air path between the simulated trachea and the first simulated lung. For example, a symmetrical air resistance may result in the air path having an equal or similar resistance during both inspiration and expiration. On the other hand, an asymmetrical air resistance may result in the air path having a different resistance during inspiration and expiration (e.g., lesser during inspiration than expiration, or vice versa).

In some instances, the asthma simulation module further comprises a second simulated lung. In this regard, the first and second simulated lungs may rely upon a common adjustable valve and/or a common air trapping module to simulate the asthmatic breathing pattern. For example, the adjustable valve may be positioned along a third air path between the simulated trachea and the second simulated lung, and the air trapping module may be positioned along a fourth air path between the simulated trachea and the first simulated lung. In some instances, the system may include an independent asthma simulation module for each of the first and second simulated lungs. Accordingly, in some aspects, the system further includes a second asthma simulation module positioned within the simulated body portion. The second asthma simulation module may include a second simulated lung, a second adjustable valve along a third air path between the simulated trachea and the second simulated lung, and a second air trapping module along a fourth air path between the simulated trachea and the second simulated lung.

The simulated body portion may include a simulated torso. The asthma simulation module(s) may be positioned within the simulated torso. The simulated body portion may also include a simulated neck coupled to the simulated torso. The simulated trachea may be positioned within the simulated neck. In this regard, when the patient simulator includes two asthma simulation modules, each asthma simulation module may be in communication with a common trachea. In some instances, the patient simulator is configured to interface with an external ventilator. The external ventilator may include any type of commercially available ventilator, including without limitation bag valve masks as well as computerized or automated ventilators. In this regard, in some instances the external ventilator may be configured to detect the asthmatic breathing pattern, in addition to providing other breathing functionalities to the patient simulator.

In some aspects of the present disclosure, a method of teaching patient care is provided. The method may include providing a patient simulator having a simulated body portion and an asthma simulation module positioned within the simulated body portion, the asthma simulation module including a first simulated lung, an adjustable valve along a first air path between a simulated trachea and the first simulated lung; and an air trapping module along a second air path between the simulated trachea and the first simulated lung; and simulating an asthmatic breathing pattern using the asthma simulation module of the patient simulator.

In some instances, simulating the asthmatic breathing pattern comprises causing air to travel between the trachea and the first simulated lung along the second air path during inspiration and causing air to travel between the first simulated lung and the trachea along the first air path during expiration. An air resistance along the first air path during expiration may be greater than an air resistance along the second air path during inspiration. In some aspects, causing the air to travel between the first simulated lung and the trachea along the first air path during expiration comprises trapping air within a cavity of the air trapping module. In this regard, trapping air within the cavity of the air trapping module may include blocking a port of the air trapping module with a flapper. In some instances, causing air to travel between the trachea and the first simulated lung along the second air path during inspiration may include displacing the flapper relative to the port of the air trapping module. Displacing the flapper may include displacing the flapper with the air traveling along the second air path.

In some aspects, simulating the asthmatic breathing pattern comprises moving the air trapping module between a first configuration and a second configuration. In the first configuration, the air trapping module allows air flow along the first air path from the simulated trachea to the first simulated lung. In the second configuration, the air trapping module prevents air flow along the first air path from a cavity of the air trapping module to the simulated trachea. Moving the air trapping module between the first configuration and the second configuration may comprise selectively inflating and deflating a bellow. In this regard, a deflated position of the bellow may be associated with the first configuration, while an inflated position of the bellow may be associated with the second configuration. Selectively inflating and deflating the bellow may include controlling at least one valve in communication with an air supply and the bellow. The at least one valve may be configured to connect the air supply to the bellow to inflate the bellow and connect the bellow to atmosphere to deflate the bellow.

In some aspects, the method also includes controlling an air resistance of the first air path between the simulated trachea and the first simulated lung using the adjustable valve. The air resistance of the first air path between the simulated trachea and the first simulated lung may be controlled using the adjustable valve to provide a symmetrical and/or an asymmetrical air resistance between inspiration and expiration.

In some instances, the asthma simulation module further comprises a second simulated lung. Simulating the asthmatic breathing pattern using the asthma simulation module of the patient simulator may comprise simulating the asthmatic breathing pattern with the first simulated lung, the second simulated lung, and/or a combination of the first and second simulated lungs. In this regard, in some instances the method includes independently controlling one or more parameters of the asthmatic breathing pattern for each of the first simulated lung and the second simulated lung. In some instances, the method includes jointly controlling one or more parameters of the asthmatic breathing pattern for both of the first simulated lung and the second simulated lung.

In some aspects, the method includes coupling an external ventilator to the patient simulator. The external ventilator may be configured to detect the asthmatic breathing pattern, in addition to providing other breathing functionalities to the patient simulator.

Other aspects, features, and embodiments of the present invention will become apparent to those of ordinary skill in the art, upon reviewing the following description of specific, exemplary instances of the present invention in conjunction with the accompanying figures. While features of the present invention may be discussed relative to certain examples and figures below, all aspects of the present invention can include one or more of the advantageous features discussed herein. In other words, while one or more arrangements may be discussed as having certain advantageous features, one or more of such features may also be used in accordance with the various aspects and examples of the invention discussed herein. In similar fashion, while exemplary aspects may be discussed below in the context of a device, a system, or a method, it should be understood that such exemplary aspects can be implemented in various devices, systems, and methods.

### BRIEF DESCRIPTION OF THE DRAWINGS

Other features and advantages of the present disclosure will become apparent in the following detailed description of illustrative embodiments with reference to the accompanying of drawings, of which:

FIG. 1 is a perspective view of a patient simulator incorporating aspects of the present disclosure.

FIG. 2 is a diagrammatic schematic view of a portion of the patient simulator of FIG. 1 including an asthma simulation module according to aspects of the present disclosure.

FIG. 3A is a diagrammatic schematic view of an air trapping module according to aspects of the present disclosure.

FIG. 3B is a diagrammatic schematic view of an air trapping module according to aspects of the present disclosure.

FIG. 3C is a diagrammatic schematic view of an air trapping module according to aspects of the present disclosure.

FIG. 4A is a diagrammatic schematic view of an asthma simulation module during inspiration according to aspects of the present disclosure.

FIG. 4B is a diagrammatic schematic view of an asthma simulation module during expiration according to aspects of the present disclosure.

FIG. 5A is a diagrammatic schematic view of an asthma simulation module during inspiration according to aspects of the present disclosure.

FIG. 5B is a diagrammatic schematic view of an asthma simulation module during expiration according to aspects of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately. For simplicity, in some instances the same reference numbers are used throughout the drawings to refer to the same or like parts.

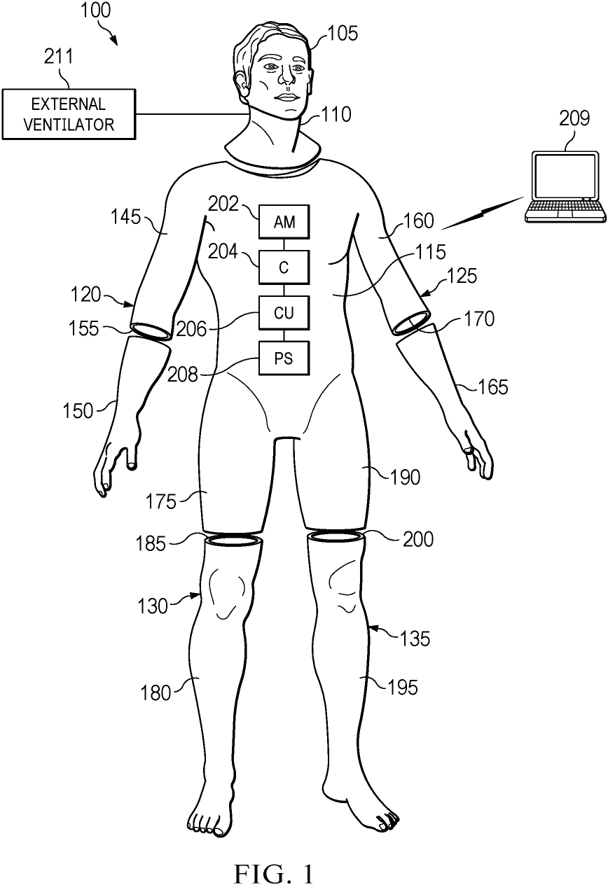

Referring to FIG. 1, a patient simulator 100 in accordance with the present disclosure may include a simulated head 105, a simulated neck 110, a simulated torso 115, a simulated right arm 120 (or “extremity”), a simulated left arm 125 (or “extremity”), a simulated right leg 130 (or “extremity”), and a simulated left leg 135 (or “extremity”). In several embodiments, the patient simulator is, includes, or is part of, a manikin. The simulated head 105 is coupled to the simulated neck 110; for example, the simulated head 105 may be releasably coupled and/or integrally formed with the simulated neck 110. The simulated neck 110 may be releasably coupled and/or integrally formed with the simulated torso 115. The simulated right arm 120 includes a simulated upper right arm 145 (or “extremity”) and a simulated lower right arm 150 (or “extremity”). The simulated upper right arm 145 may be releasably coupled and/or integrally formed with the simulated torso 115. The simulated lower right arm 150 may be releasably coupled and/or integrally formed with the simulated upper right arm 145. In some instances, the simulated lower right arm 150 is coupled with the simulated upper right arm 145 via a right arm coupling 155. Similarly, the simulated left arm 125 includes a simulated upper left arm 160 (or “extremity”) and a simulated lower left arm 165 (or “extremity”). The simulated upper left arm 160 may be releasably coupled and/or integrally formed with the simulated torso 115. The simulated lower left arm 165 may be releasably coupled and/or integrally formed with the simulated upper left arm 160. In some instances, the simulated lower left arm 165 is coupled with the simulated upper left arm 160 via a left arm coupling 170.

The simulated right leg 130 includes a simulated upper right leg 175 (or “extremity”) and a simulated lower right leg 180 (or “extremity”). The simulated upper right leg 175 may be releasably coupled and/or integrally formed with the simulated torso 115. The simulated lower right leg 180 may be releasably coupled and/or integrally formed with the simulated upper right leg 175. In some instances, the simulated lower right leg 180 is coupled with the simulated upper right leg 175 via a right leg coupling 185. Similarly, the simulated left leg 135 includes a simulated upper left leg 190 (or “extremity”) and a simulated lower left leg 195 (or “extremity”). The simulated upper left leg 190 may be releasably coupled and/or integrally formed with the simulated torso 115. The simulated lower left leg 195 may be releasably coupled and/or integrally formed with the simulated upper left leg 190. In some instances, the simulated lower left leg 195 is coupled with the simulated upper left leg 190 via a left leg coupling 200.

The patient simulator 100 can include one or more of an asthma simulation module 202, a compressor 204, a control unit 206, and/or a power source 208. In some instances, the compressor 204, the control unit 206, and/or the power source 208 may be components of the asthma simulation module 202. In some instances, the asthma simulation module 202 of the patient simulator 100 may be configured to generate a simulated breathing pattern and/or one or more breathing parameters for the patient simulator 100, including those associated with asthmatic breathing as well as normal breathing. Asthmatic breathing includes both natural asthmatic events as well as auto-positive end expiratory pressure (auto-PEEP) that may be common in patients coupled to an external ventilator. Accordingly, it is understood that the asthma simulation module 202 and/or other aspects of the present disclosure are suitable for simulating asthmatic, auto-PEEP, and/or other breathing patterns where air flow does not return to zero at the end of expiration or exhalation, whether naturally or through the use of an external ventilator. In this regard, the asthma simulation module 202 may be configured to simulate the natural lung mechanics associated with connecting natural lungs to external ventilators. As a general matter, lung compliance is a measure of air volume change relative to applied pressure change. Lungs that stretch too much (too flexible) are said to be high compliance lungs, whereas lungs that stretch too little (too stiff) are said to be low compliance lungs. The asthma simulation module 202 may simulate normal, high, and low compliance lungs. In that regard, the asthma simulation module 202 may increase and/or decrease the volume capacity of one or more simulated lungs to replicate natural lung compliance. In this regard, the asthma simulation module 202 may include one or more aspects of the lung compliance systems described in U.S. Pat. Application No. 14/930,178, now U.S. Pat. No. 9,697,750, which is hereby incorporated by reference in its entirety for all applicable purposes.

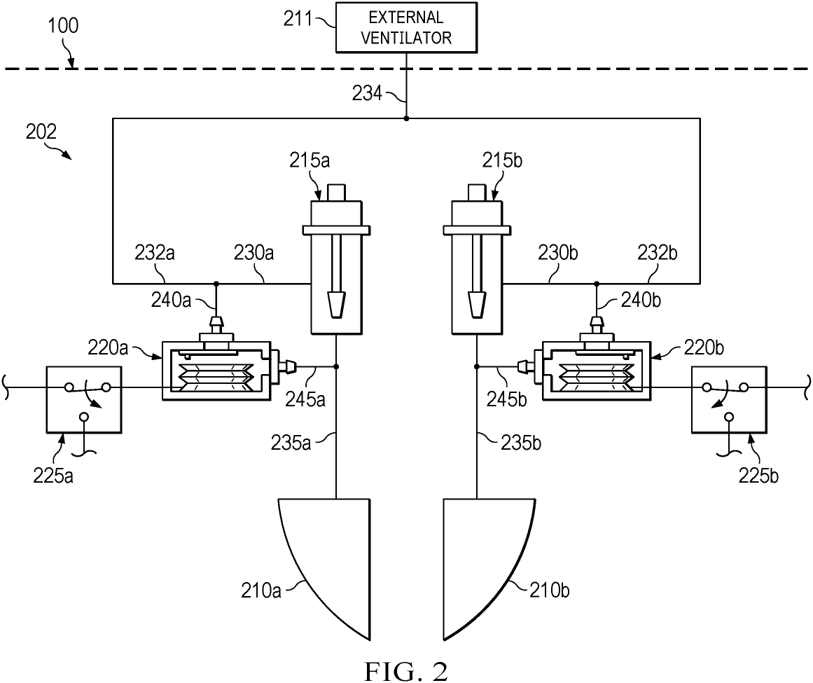

As will be described in greater detail below, the asthma simulation module 202 may be configured to interface with an external ventilator 211 in order simulate breathing parameters associated with the patient simulator 100, including asthmatic breathing patterns. The external ventilator 211 may include any type of commercially available ventilator, including without limitation bag valve masks as well as computerized or automated ventilators. In this regard, in some instances the external ventilator may be configured to detect the asthmatic breathing pattern, in addition to providing other breathing functionalities to the patient simulator. Additional features and aspects of the asthma simulation module 202 and the interactions between the patient simulator 100 and the external ventilator 211 are described below in the context of FIGS. 2-5b.

The compressor 204 may be adapted to supply pneumatic pressure to various features/components of the patient simulator 100, including components of the asthma simulation module 202. Such features/components to which pneumatic pressure is supplied by the compressor 204 may be contained in the simulated torso 115, the simulated head 105, the simulated right arm 120, the simulated left arm 125, the simulated right leg 130, and/or the simulated left leg 135. In some instances, the compressor 204 is a scroll compressor.

The control unit 206 may be adapted to control aspects and/or components of the asthma simulation module 202, the compressor 204, and/or various other features/components of the patient simulator 100 that may be contained in the simulated torso 115, the simulated head 105, the simulated right arm 120, the simulated left arm 125, the simulated right leg 130, and/or the simulated left leg 135. In some instances, the control unit 206 is configured to control aspects and/or components of the asthma simulation module 202, the compressor 204, and/or various other features/components of the patient simulator 100 based on inputs from a controller 209 in communication with the patient simulator 100. The controller 209 may be in wireless (RF, Wi-Fi, Bluetooth, optical, etc.) and/or wired communication with the patient simulator 100. In this regard, the patient simulator 100 may be configured to simulate one or more parameters in response to settings and/or programs of the controller 209. In this regard, the one or more parameters may be based on user inputs, a simulation profile, and/or a combination thereof. For example, in some instances, a simulated breathing pattern and/or one or more breathing parameters of the patient simulator 100 may be set by a user, a simulation profile defined by or running on the controller 209, and/or combinations thereof. In this regard, the controller 209 may include a plurality of pre-programed and/or custom simulation profiles that are each configured to set the breathing pattern and/or one or more breathing parameters of the patient simulator 100 (along with other parameters) over time. The simulation profile(s) may cause the breathing pattern and/or one or more breathing parameters of the patient simulator 100 to change over time in accordance with a simulated medical scenario. In some instances, the simulation profile(s) may adjust aspects of the breathing pattern and/or one or more breathing parameters of the patient simulator 100 over time based at least in part on actions and/or interventions taken by a user to treat the patient simulator.

The power source 208 may be adapted to supply electrical power to the asthma simulation module 202, the compressor 204, the control unit 206, and/or various other features/components of the patient simulator 100 that may be contained in the simulated torso 115, the simulated head 105, the simulated right arm 120, the simulated left arm 125, the simulated right leg 130, and/or the simulated left leg 135. The power source 208 may include one or more batteries, capacitors, and/or other power storage components. The power source 208 may also include one or more controllers, processors, application specific integrated circuits (ASICs), amplifiers, switches, and/or other components configured to control the distribution of power to the various components of the patient simulator.

It is understood that the illustrated embodiment of the patient simulator 100 is sized and shaped to represent a patient that will receive treatment. In that regard, the patient simulator can take a variety of forms, including a manikin sized and shaped to represent male or female patients of any size, age, and/or health, ranging from premature fetus to full-sized adults. Further, the patient simulator may include only a portion of the simulated patient (e.g., specific body parts or combinations of body parts). Accordingly, while aspects of the present disclosure are described with respect to particular embodiments of patient simulators, no limitation is intended thereby. It is understood that the features of the present disclosure may be incorporated into or utilized in conjunction with any suitable patient simulators. In some instances, aspects of the present disclosure are configured for use with the simulators and the related features disclosed in U.S. Pat. Application No. 11/952,559 (Publication No. 20080138778), U.S. Pat. Application No. 11/952,606 (Publication No. 20080131855), U.S. Pat. Application No. 11/952,636 (Publication No. 20080138779), U.S. Pat. Application No. 11/952,669 (Publication No. 20090148822), U.S. Pat. Application No. 11/952,698 (Publication No. 20080138780), U.S. Pat. No. 7,114,954, U.S. Pat. No. 6,758,676, U.S. Pat. No. 6,503,087, U.S. Pat. No. 6,527,558, U.S. Pat. No. 6,443,735, U.S. Pat. No. 6,193,519, and U.S. Pat. No. 5,853,292, each herein incorporated by reference in its entirety.

Referring now to FIG. 2, shown therein are additional aspects of the patient simulator 100 according to aspects of the present disclosure. In this regard, FIG. 2 is a diagrammatic schematic view of a portion of the patient simulator 100 interfacing with an external ventilator 211 according to aspects of the present disclosure. As shown, a portion of the patient simulator 100 includes components of the asthma simulation module 202. In some instances, one or more components of the asthma simulation module 202 are positioned within the head 105, the neck 110, and/or the torso 115 of the patient simulator 100. However, one or more components of the asthma simulation module 202 may be positioned within other portions of the patient simulator 100 as well. In some instances, the external ventilator 211 interfaces with an external orifice of the patient simulator 100, such as a simulated mouth and/or nose. In such instances, the interface or connection between the external ventilator 211 and the external orifice(s) mimics the interface or connection between the external ventilator and a natural patient. In this regard, the external orifice(s) may be in communication with a simulated trachea/airway 234 of the patient simulator 100.

As shown in FIG. 2, the asthma simulation module 202 can include a simulated right lung 210a and a simulated left lung 210b. In some instances, the asthma simulation module 202 may include an independent asthma simulation module or system for each of the simulated right lung 210a and the simulated left lung 210b. In the illustrated example of FIG. 2, the components of the asthma simulation module 202 with the suffix “a” may be associated with controlling breathing patterns and/or breathing parameters associated with the simulated right lung 210a, while the components of the asthma simulation module 202 with the suffix “b” may be associated with controlling breathing patterns and/or breathing parameters associated with the simulated left lung 210b. In this regard, the breathing patterns and/or breathing parameters of the simulated right and left lungs 210a, 210b may be controlled independently and/or jointly.

Referring to FIG. 2, the asthma simulation module 202 may include the simulated right lung 210a, the simulated left lung 210b, an adjustable valve 215a, an adjustable valve 215b, an air trapping module 220a, an air trapping module 220b, a valve 225a, and a valve 225b. The adjustable valve 215a may be in communication with a simulated trachea/airway 234 of the patient simulator 100 via an air way 230a and an air way 232a. The adjustable valve 215a may be in communication with the simulated right lung 210a via an air way 235a. The adjustable valve 215b may be in communication with the simulated trachea/airway 234 of the patient simulator 100 via an air way 230b and an air way 232b. The adjustable valve 215b may be in communication with the simulated left lung 210b via an air way 235b. In some instances, the adjustable valves 215a, 215b are configured to control an air resistance of an air path between the simulated trachea/airway 234 and the simulated right or left lung 210a, 210b, respectively. In this regard, the adjustable valve 215a, 215b may be configured to symmetrically and/or asymmetrically control the air resistance along the air path between the simulated trachea/airway 234 and the simulated right or left lung 210a, 210b. For example, a symmetrical air resistance may result in the air path having an equal or similar resistance during both inspiration and expiration. On the other hand, an asymmetrical air resistance may result in the air path having a different resistance during inspiration and expiration (e.g., lesser during inspiration than expiration, or vice versa).

The air trapping module 220a may be in communication with the simulated trachea/airway 234 of the patient simulator 100 via an air way 240a and the air way 232a. The air trapping module 220a may be in communication with the simulated right lung 210a via an air way 245a and the air way 235a. The air trapping module 220b may be in communication with the simulated trachea/airway 234 of the patient simulator 100 via an air way 240b and the air way 232b. The air trapping module 220b may be in communication with the simulated left lung 210b via an air way 245b and the air way 235a.

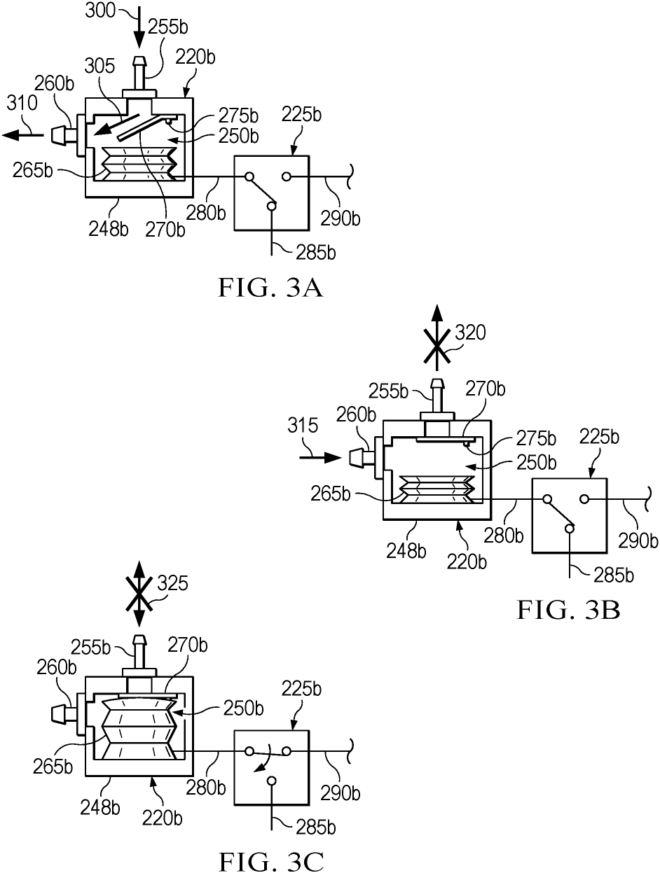

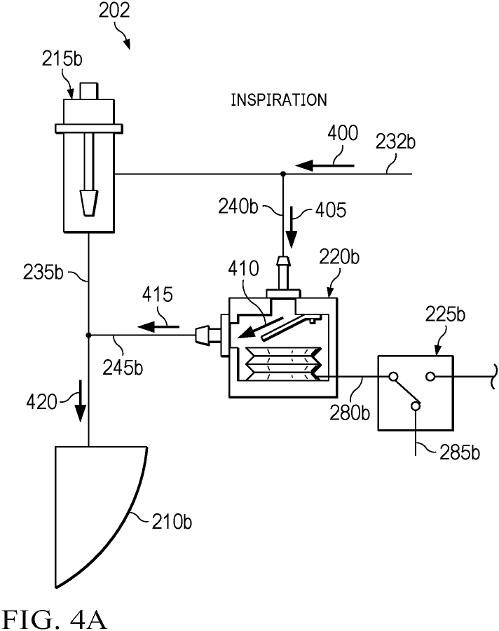

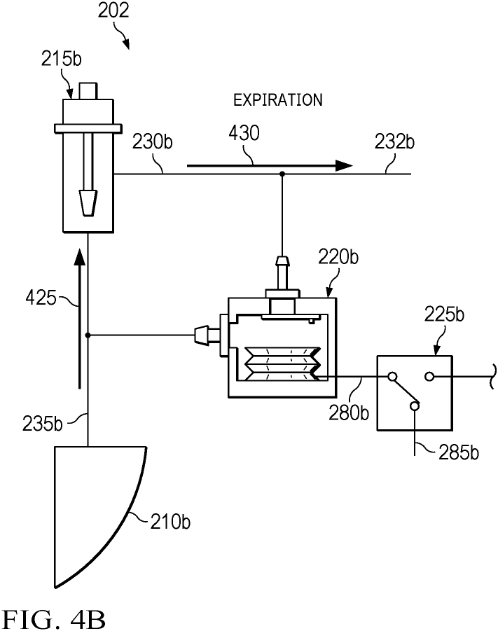

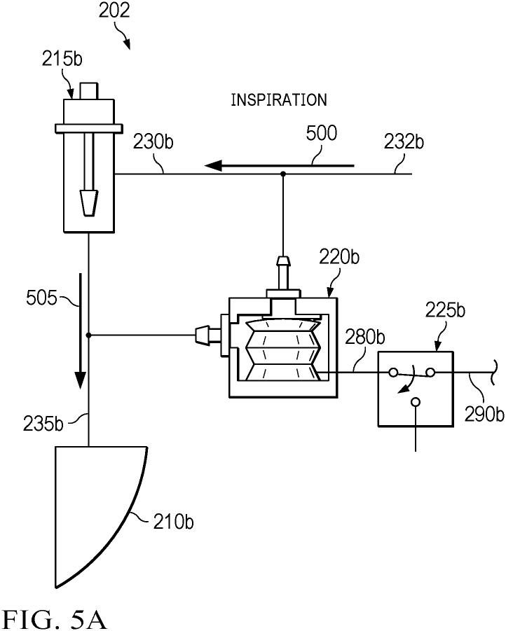

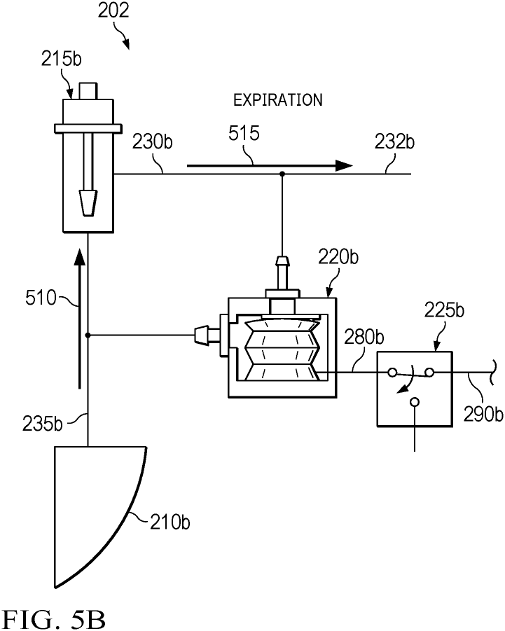

In some instances, the air trapping modules 220a, 220b may be configured to move between a first configuration (see, e.g., FIGS. 3A, 3B, 4A, and 4B) and a second configuration (see, e.g., FIGS. 3C, 5A, and 5B). In the first configuration, the air trapping module may allow air flow through the air trapping module 220a, 220b from the simulated trachea/airway 234 to the simulated right or left lung 210a, 210b, respectively, while preventing air flow through the air trapping module 220a, 220b from the simulated right or left lung 210a, 210b to the simulated trachea/airway 234. Accordingly, in the first configuration, the air trapping module 220a, 220b may allow air flow along a first air path from the simulated trachea/airway 234 to the simulated right or left lung 210a, 210b and/or prevent air flow along the first air path from the air trapping module 220a, 220b to the simulated trachea/airway 234. In the second configuration, the air trapping module 220a, 220b may prevent air flow through the air trapping module 220a, 220b in any direction. Accordingly, in the second configuration, the air trapping module 220a, 220b may prevent air flow along a first air path from a cavity of the air trapping module 220a, 220b to the simulated trachea/airway 234 and/or prevent air flow along the first air path from the simulated trachea/airway 234 to the simulated right or left lung 210a, 210b.

The valves 225a, 225b may be in communication with an air supply (e.g., a compressor, compressed gas/air canister, or other source of gas/air). In this regard, the valves 225a, 225b may be connected to a common air supply (e.g., the compressor 204). In some instances, the valves 225a, 225b may be connected to separate air supplies. As discussed further with respect to FIGS. 3a-5b, in some instances the valves 225a, 225b may be utilized to control the transition of the air trapping modules 220a, 220b between the first and configurations. As noted above, the breathing patterns and/or breathing parameters of the simulated right and left lungs 210a, 210b may be controlled independently and/or jointly. In some instances, when the breathing patterns and/or breathing parameters of the simulated right and left lungs 210a, 210b are jointly controlled, one or more components of the asthma simulation module 202 may be coupled to and/or in pneumatic communication with both the simulated right and left lungs 210a, 210b. For example, in some instances a single adjustable valve, a single air trapping module, and/or a single valve may be used to control the breathing patterns and/or breathing parameters for both the simulated right and left lungs 210a, 210b (e.g., simulated right lung 210a may be coupled to air way 235b such that the adjustable valve 215b, the air trapping module 220b, and the valve 225b may be used to control breathing patterns and/or breathing parameters for the simulated right lung 210a in addition to the simulated left lung 210b).

Referring now to FIGS. 3A-3C, additional aspects of asthma simulation module 202 related to the air trapping modules 220a, 220b and the valves 225a, 225b will be described. In this regard, FIGS. 3A-3C illustrate the air trapping module 220b and the valve 225b. However, it is understood that the air trapping module 220a and the valve 225a may have similar and/or identical features. As shown in FIG. 3A, the air trapping module 220b comprises a housing 248b having a cavity 250b, a port 255b, and a port 260b. The port 255b may be in communication with the cavity 250b. The port 260b may be in communication with the cavity 250b. The air trapping module 220b may also include a flapper 270b coupled to the housing 248b. The flapper 270b may be coupled to the housing 248b using any suitable technique, including mechanical coupling(s), adhesive(s), and/or combinations thereof. In the illustrated example, the flapper 270b is coupled to the housing 248b via mechanical coupling (e.g., pin, nail, screw, bolt, etc.). The flapper 270b may be configured to allow air flow along the first air path from the simulated trachea/airway 234 to the simulated left lung 210b (see, e.g., FIGS. 3A and 4A) and prevent air flow along the first air path from the cavity 250b to the simulated trachea/airway 234 (see, e.g., FIGS. 3B and 4B) when the air trapping module is in the first configuration.

In some instances, the air trapping module 220b further comprises a bellow 265b positioned within the housing 248b. The bellow 265b may be movable between a deflated position (see, e.g., FIGS. 3A, 3B, 4A, and 4B) associated with the first configuration and an inflated position (see, e.g., FIGS. 3C, 5A, and 5B) associated with the second configuration. In some aspects, the patient simulator 100 and/or the asthma simulation module 202 further comprises an air supply (e.g., compressor 204) and at least one valve (e.g., valve 225b) in communication with the air supply and the bellow 265b. The valve 225b may be configured to connect the air supply to the bellow 265b and connect the bellow 265b to atmosphere. For example, as shown in FIG. 3A, the valve 225b may include a port 280b, a port 285b, and a port 290b. The port 280b may connect the valve 225b to the bellow 265b. The port 285b may connect the valve 225b to atmosphere, either inside or outside of the patient simulator 100. The port 290b may connect the valve to the air supply. By selectively connecting the port 280b to either the port 285b or the port 290b, the valve 225b can selectively deflate and inflate the bellow 265b. For example, when the port 280b is connected to the port 285b (see, e.g., FIGS. 3A and 3B), then the air in the bellow 265b is released to atmosphere. As a result, the bellow 265b is deflated to a first configuration, as shown in FIGS. 3A, 3B, 4A, and 4B. On the other hand, when the port 280b is connected to the port 290b (see, e.g., FIG. 3C), then air from the air supply flows into the bellow 265b. As a result, the bellow is inflated to a second configuration, as shown in FIGS. 3C, 5A, and 5B. By controlling the position of the valve 225b to connect the desired ports (e.g., port 280b to port 285b, or port 280b to port 290b) the single valve 225b may be configured to connect the air supply to the bellow in a first position and connect the bellow to atmosphere in a second position. In some instances, instead of a single valve, multiple valves are utilized to achieve similar functionality. For example, a first valve may be used for connecting the air supply to the bellow 265b and a second valve may be used for connecting the bellow 265b to atmosphere. In some instances, a processor in communication with the air supply and/or the valve 225b is configured to control the valve 225b to selectively move the bellow 265b between the deflated position and the inflated position. In this manner, the processor may control the configuration of the air trapping module 220b. In some instances, the bellow 265b may be replaced with a mechanical component (e.g., piston) driven pneumatically, by an electrical motor, and/or other actuator to selectively contact and/or block the flapper 270b to prevent displacement of the flapper 270b during inspiration as discussed below.

In some instances, the asthma simulation module 202 may include one or more connectors, adapters, ports, tubes, and/or other couplings to facilitate pneumatic connections between the simulated right lung 210a, the simulated left lung 210b, the adjustable valve 215a, the adjustable valve 215b, the air trapping module 220a, the air trapping module 220b, the valve 225a, the valve 225b, the bellow 265a, the bellow 265b, the air supply (e.g., compressor 204), and/or the external ventilator 211. Generally speaking, any suitable connectors, adapters, ports, tubes, and/or other couplings may be utilized.

As shown in FIG. 3A, when the air trapping module 220b is in the first configuration (e.g., with the bellow 265b deflated), air is able to flow into port 255b (see arrow 300), into the cavity 250b by displacing flapper 270b, through the cavity 250b (see arrow 305), and out through port 260b (see arrow 310). In some instances, the air flow along arrows 300, 305, and 310 may be associated with inspiration to the simulated left lung 210b when the air trapping module 220b is in the first configuration.

As shown in FIG. 3B, when the air trapping module 220b is in the first configuration (e.g., with the bellow 265b deflated), air is able to flow into port 260b (see arrow 315), but the air is in then trapped within the cavity 250b of the air trapping module 220b. In this regard, the flapper 270b may cover and/or block the port 255b. As a result, air cannot flow through the port 255b, as indicated by the crossed through arrow 320. In some instances, the air flow along arrow 315 and/or the trapping of air within the air trapping module 220b may be associated with expiration from the simulated left lung 210b when the air trapping module 220b is in the first configuration. In this regard, in some instances the air trapping module 220b may be positioned in the first configuration for simulating asthmatic breathing patterns.

As shown in FIG. 3C, when the air trapping module 220b is in the second configuration (e.g., with the bellow 265b inflated), air is not able to flow into or out of the port 255b. In this regard, the flapper 270b may cover and/or block the port 255b and the bellow 265b prevents displacement of the flapper 270b. As a result, air cannot flow between the port 255b and the cavity 250b in either direction, as indicated by the crossed through arrow 320. In some instances, the air trapping module 220b may be positioned in the second configuration in order to require air to flow through the adjustable valve 215b during inspiration and/or expiration. In this regard, in some instances the air trapping module 220b may be positioned in the second configuration for simulating normal (non-asthmatic) breathing patterns. For example, by bypassing the air trapping module 220b during inspiration and expiration, the air path between the simulated trachea/airway 234 and the simulated left lung 210b may have an equal or approximately equal resistance during both inspiration and expiration consistent with non-asthmatic breathing.

Referring now to FIGS. 4A and 4B, air flows associated with inspiration (FIG. 4A) and expiration (FIG. 4B) according to aspects of the present disclosure are illustrated. In this regard, FIGS. 4A and 4B illustrate air flows associated with inspiration and expiration with the asthma simulation module 202 in a first configuration (e.g., with the air trapping module(s) active). As shown in FIG. 4A, during inspiration air may flow along air way 232b (see arrow 400), along air way 240b (see arrow 405), through the air trapping module 220b (see arrow 410), along air way 245b (see arrow 415), and along air way 235b (see arrow 420) to the simulated left lung 210b. As shown in FIG. 4B, during expiration air may flow along air way 235b (see arrow 425), through the adjustable valve 215b, and along air ways 230b and 232b (see arrow 430) to the simulated trachea/airway 234. In this regard, during expiration some air from the simulated left lung 210b may flow into the air trapping module 220b but will be trapped in the air trapping module 220b. Once the resistance along the path into the air trapping module 220b meets or exceeds the resistance of the adjustable valve 215b, then the remainder of the air from the simulated lung 210b will travel along the air path shown in FIG. 4B. The relatively free flow of air into the simulated left lung 210b during inspiration (as shown in FIG. 4A) combined with the restricted flow of air out of the simulated left lung 210b and through the adjustable valve 215b during expiration (as shown in FIG. 4B) may be utilized to simulate one or more asthmatic breathing patterns in accordance with the present disclosure.

Referring now to FIGS. 5A and 5B, air flows associated with inspiration (FIG. 5A) and expiration (FIG. 5B) according to aspects of the present disclosure are illustrated. In this regard, FIGS. 5A and 5B illustrate air flows associated with inspiration and expiration with the asthma simulation module 202 in a second configuration (e.g., with the air trapping module(s) inactive or disabled). As shown in FIG. 5A, during inspiration air may flow along air ways 232b and 230b (see arrow 500), through the adjustable valve 215b (see arrow 410), and along air way 235b (see arrow 505) to the simulated left lung 210b. As shown in FIG. 5B, during expiration air may flow in the reverse path of FIG. 5A, namely along air way 235b (see arrow 510), through the adjustable valve 215b, and along air ways 230b and 232b (see arrow 515) to the simulated trachea/airway 234. In this regard, by bypassing the air trapping module 220b during both inspiration and expiration, the air path between the simulated trachea/airway 234 and the simulated left lung 210b may have an equal or approximately equal resistance during both inspiration and expiration. Accordingly, the configuration of FIGS. 5A and 5B may be utilized to simulate one or more non-asthmatic breathing patterns in accordance with the present disclosure.

In some aspects of the present disclosure, a method of teaching patient care is provided. The method may utilize the patient simulator 100 and associated components described above with respect to FIGS. 1-5C. The method may include providing a patient simulator having a simulated body portion and an asthma simulation module positioned within the simulated body portion, the asthma simulation module including a first simulated lung, an adjustable valve along a first air path between a simulated trachea and the first simulated lung; and an air trapping module along a second air path between the simulated trachea and the first simulated lung; and simulating an asthmatic breathing pattern using the asthma simulation module of the patient simulator.

In some instances, simulating the asthmatic breathing pattern comprises causing air to travel between the trachea and the first simulated lung along the second air path during inspiration and causing air to travel between the first simulated lung and the trachea along the first air path during expiration. An air resistance along the first air path during expiration may be greater than an air resistance along the second air path during inspiration. In some aspects, causing the air to travel between the first simulated lung and the trachea along the first air path during expiration comprises trapping air within a cavity of the air trapping module. In this regard, trapping air within the cavity of the air trapping module may include blocking a port of the air trapping module with a flapper. In some instances, causing air to travel between the trachea and the first simulated lung along the second air path during inspiration may include displacing the flapper relative to the port of the air trapping module. Displacing the flapper may include displacing the flapper with the air traveling along the second air path.

In some aspects, simulating the asthmatic breathing pattern comprises moving the air trapping module between a first configuration and a second configuration. In the first configuration, the air trapping module allows air flow along the first air path from the simulated trachea to the first simulated lung. In the second configuration, the air trapping module prevents air flow along the first air path from a cavity of the air trapping module to the simulated trachea. Moving the air trapping module between the first configuration and the second configuration may comprise selectively inflating and deflating a bellow. In this regard, a deflated position of the bellow may be associated with the first configuration, while an inflated position of the bellow may be associated with the second configuration. Selectively inflating and deflating the bellow may include controlling at least one valve in communication with an air supply and the bellow. The at least one valve may be configured to connect the air supply to the bellow to inflate the bellow and connect the bellow to atmosphere to deflate the bellow.

In some aspects, the method also includes controlling an air resistance of the first air path between the simulated trachea and the first simulated lung using the adjustable valve. The air resistance of the first air path between the simulated trachea and the first simulated lung may be controlled using the adjustable valve to provide a symmetrical and/or an asymmetrical air resistance between inspiration and expiration.

In some instances, the asthma simulation module further comprises a second simulated lung. Simulating the asthmatic breathing pattern using the asthma simulation module of the patient simulator may comprise simulating the asthmatic breathing pattern with the first simulated lung, the second simulated lung, and/or a combination of the first and second simulated lungs. In this regard, in some instances the method includes independently controlling one or more parameters of the asthmatic breathing pattern for each of the first simulated lung and the second simulated lung. In some instances, the method includes jointly controlling one or more parameters of the asthmatic breathing pattern for both of the first simulated lung and the second simulated lung.

In some aspects, the method includes coupling an external ventilator to the patient simulator. The external ventilator may be configured to detect the asthmatic breathing pattern, in addition to providing other breathing functionalities to the patient simulator.

In some aspects of the present disclosure, a system for teaching patient care is provided. The system may include a patient simulator with a patient body comprised of one or more simulated body portions. The one or more simulated body portions may include a torso, neck, and/or head. An asthma simulation module may be positioned within the simulated body portion. The asthma simulation module may include a first simulated lung, an adjustable valve along a first air path between a simulated trachea and the first simulated lung, and an air trapping module along a second air path between the simulated trachea and the first simulated lung. In some instances, the air trapping module may be configured to move between a first configuration and a second configuration. In the first configuration, the air trapping module may allow air flow along the first air path from the simulated trachea to the first simulated lung and/or prevent air flow along the first air path from the cavity of the air trapping module to the first simulated lung. In the second configuration, the air trapping module may prevent air flow along the first air path from a cavity of the air trapping module to the simulated trachea and/or prevent air flow along the first air path from the simulated trachea to the first simulated lung.

In some aspects, the air trapping module comprises a housing having a cavity, a first port in communication with the cavity, and a second port in communication with the cavity. The air trapping module may also include a flapper coupled to the housing. The flapper may be configured to allow air flow along the first air path from the simulated trachea to the first simulated lung and prevent air flow along the first air path from the cavity to the first simulated lung when the air trapping module is in the first configuration. In some instances, the air trapping module further comprises a bellow positioned within the housing. The bellow may be movable between a deflated position associated with the first configuration and an inflated position associated with the second configuration. In some aspects, the system further comprises an air supply and at least one valve in communication with the air supply and the bellow. The at least one valve may be configured to connect the air supply to the bellow and connect the bellow to atmosphere. The air supply may include a compressor, compressed gas/air canister, and/or other source of gas/air. The at least one valve may comprise a single valve configured to connect the air supply to the bellow in a first position and connect the bellow to atmosphere in a second position. The at least one valve may comprise a first valve for connecting the air supply to the bellow and a second valve for connecting the bellow to atmosphere. The system may also include at least one processor in communication with the air supply and the at least one valve. The at least one processor may be configured to control the at least one valve to selectively move the bellow between the deflated position and the inflated position.

In some instances, the adjustable valve is configured to control an air resistance of the first air path between the simulated trachea and the first simulated lung. In this regard, the adjustable valve may be configured to symmetrically and/or asymmetrically control the air resistance of the first air path between the simulated trachea and the first simulated lung. For example, a symmetrical air resistance may result in the air path having an equal or similar resistance during both inspiration and expiration. On the other hand, an asymmetrical air resistance may result in the air path having a different resistance during inspiration and expiration (e.g., lesser during inspiration than expiration, or vice versa).

In some instances, the asthma simulation module further comprises a second simulated lung. In this regard, the first and second simulated lungs may rely upon a common adjustable valve and/or a common air trapping module to simulate the asthmatic breathing pattern. For example, the adjustable valve may be positioned along a third air path between the simulated trachea and the second simulated lung, and the air trapping module may be positioned along a fourth air path between the simulated trachea and the first simulated lung. In some instances, the system may include an independent asthma simulation module for each of the first and second simulated lungs. Accordingly, in some aspects, the system further includes a second asthma simulation module positioned within the simulated body portion. The second asthma simulation module may include a second simulated lung, a second adjustable valve along a third air path between the simulated trachea and the second simulated lung, and a second air trapping module along a fourth air path between the simulated trachea and the second simulated lung.

The simulated body portion may include a simulated torso. The asthma simulation module(s) may be positioned within the simulated torso. The simulated body portion may also include a simulated neck coupled to the simulated torso. The simulated trachea may be positioned within the simulated neck. In this regard, when the patient simulator includes two asthma simulation modules, each asthma simulation module may be in communication with a common trachea. In some instances, the patient simulator is configured to interface with an external ventilator. The external ventilator may include any type of commercially available ventilator, including without limitation bag valve masks as well as computerized or automated ventilators. In this regard, in some instances the external ventilator may be configured to detect the asthmatic breathing pattern, in addition to providing other breathing functionalities to the patient simulator.

Although illustrative embodiments have been shown and described, a wide range of modification, change, and substitution is contemplated in the foregoing disclosure and in some instances, some features of the present disclosure may be employed without a corresponding use of the other features. It is understood that such variations may be made in the foregoing without departing from the scope of the embodiment. Accordingly, it is appropriate that the appended claims be construed broadly and in a manner consistent with the scope of the present disclosure.

What is claimed is:

1. A system, comprising:
a patient simulator having a simulated body portion; and
an asthma simulation module positioned within the simulated body portion, the asthma simulation module including:
a first simulated lung;
an adjustable valve along a first air path between a simulated trachea and the first simulated lung; and
an air trapping module along a second air path between the simulated trachea and the first simulated lung.

2. The system of claim 1, wherein:
the air trapping module is configured to move between a first configuration and a second configuration;
in the first configuration, the air trapping module is configured to allow air flow along the first air path from the simulated trachea to the first simulated lung; and
in the second configuration, the air trapping module is configured to prevent air flow along the first air path from a cavity of the air trapping module to the simulated trachea.

3. The system of claim 2, wherein:
in the first configuration, the air trapping module is configured to prevent air flow along the first air path from the cavity of the air trapping module to the simulated trachea; and
in the second configuration, the air trapping module is configured to prevent air flow along the first air path from the simulated trachea to the first simulated lung.

4. The system of claim 3, wherein the air trapping module comprises:
a housing having the cavity, a first port in communication with the cavity, and a second port in communication with the cavity; and
a flapper coupled to the housing, the flapper configured to allow air flow along the first air path from the simulated trachea to the first simulated lung and prevent air flow along the first air path from the cavity to the simulated trachea when the air trapping module is in the first configuration.

5. The system of claim 4, wherein the air trapping module further comprises:
a bellow positioned within the housing, the bellow movable between a deflated position associated with the first configuration and an inflated position associated with the second configuration.

6. The system of claim 5, further comprising:
an air supply; and
at least one valve in communication with the air supply and the bellow, wherein the at least one valve is configured to connect the air supply to the bellow and connect the bellow to atmosphere.

7. The system of claim 6, wherein the air supply includes a compressor.

8. The system of claim 6, wherein the at least one valve comprises a single valve configured to connect the air supply to the bellow in a first position and connect the bellow to atmosphere in a second position.

9. The system of claim 6, wherein the at least one valve comprises a first valve for connecting the air supply to the bellow and a second valve for connecting the bellow to atmosphere.

10. The system of claim 6, further comprising:
at least one processor in communication with the air supply and the at least one valve, the at least one processor configured to control the at least one valve to selectively move the bellow between the deflated position and the inflated position.

11. The system of claim 1, wherein the adjustable valve is configured to control an air resistance of the first air path between the simulated trachea and the first simulated lung.

12. The system of claim 11, wherein the adjustable valve is configured to symmetrically control the air resistance of the first air path between the simulated trachea and the first simulated lung.

13. The system of claim 11, wherein the adjustable valve is configured to asymmetrically control the air resistance of the first air path between the simulated trachea and the first simulated lung.

14. The system of claim 1, wherein the asthma simulation module further comprises a second simulated lung; and wherein:
the adjustable valve is positioned along a third air path between the simulated trachea and the second simulated lung; and
the air trapping module is positioned along a fourth air path between the simulated trachea and the first simulated lung.

15. The system of claim 1, further comprising:
a second asthma simulation module positioned within the simulated body portion, the second asthma simulation module including:
a second simulated lung;
a second adjustable valve along a third air path between the simulated trachea and the second simulated lung; and
a second air trapping module along a fourth air path between the simulated trachea and the second simulated lung.

16. The system of claim 1, wherein the simulated body portion includes a simulated torso.

17. The system of claim 16, wherein the asthma simulation module is positioned within the simulated torso.

18. The system of claim 17, wherein the simulated body portion includes a simulated neck coupled to the simulated torso, wherein the simulated trachea is positioned within the simulated neck.

19. A method, comprising:
providing a patient simulator having a simulated body portion and an asthma simulation module positioned within the simulated body portion, the asthma simulation module including a first simulated lung, an adjustable valve along a first air path between a simulated trachea and the first simulated lung; and an air trapping module along a second air path between the simulated trachea and the first simulated lung; and
simulating an asthmatic breathing pattern using the asthma simulation module of the patient simulator.

20. The method of claim 19, wherein the simulating the asthmatic breathing pattern comprises:
causing air to travel between the trachea and the first simulated lung along the second air path during inspiration; and
causing air to travel between the first simulated lung and the trachea along the first air path during expiration.

21. The method of claim 20, wherein an air resistance along the first air path during expiration is greater than an air resistance along the second air path during inspiration.

22. The method of claim 20, wherein the causing the air to travel between the first simulated lung and the trachea along the first air path during expiration comprises trapping air within a cavity of the air trapping module.

23. The method of claim 22, wherein the trapping air within the cavity of the air trapping module comprises blocking a port of the air trapping module with a flapper.

24. The method of claim 23, wherein the causing air to travel between the trachea and the first simulated lung along the second air path during inspiration comprises displacing the flapper relative to the port of the air trapping module.

25. The method of claim 24, wherein the displacing the flapper includes displacing the flapper with the air traveling along the second air path.

26. The method of claim 19, wherein the simulating the asthmatic breathing pattern comprises:
moving the air trapping module between a first configuration and a second configuration,
wherein, in the first configuration, the air trapping module allows air flow along the first air path from the simulated trachea to the first simulated lung; and
wherein, in the second configuration, the air trapping module prevents air flow along the first air path from a cavity of the air trapping module to the simulated trachea.

27. The method of claim 26, wherein the moving the air trapping module between the first configuration and the second configuration comprises:
selectively inflating and deflating a bellow between a deflated position associated with the first configuration and an inflated position associated with the second configuration.

28. The method of claim 27, wherein the selectively inflating and deflating the bellow comprises:
controlling at least one valve in communication with an air supply and the bellow, wherein the at least one valve is configured to connect the air supply to the bellow to inflate the bellow and connect the bellow to atmosphere to deflate the bellow.

29. The method of claim 19, further comprising controlling an air resistance of the first air path between the simulated trachea and the first simulated lung using the adjustable valve.

30. The method of claim 29, wherein the controlling the air resistance of the first air path between the simulated trachea and the first simulated lung using the adjustable valve comprises providing a symmetrical air resistance between inspiration and expiration.

31. The method of claim 29, wherein the controlling the air resistance of the first air path between the simulated trachea and the first simulated lung using the adjustable valve comprises providing an asymmetrical air resistance between inspiration and expiration.

32. The method of claim 19, wherein:
the asthma simulation module further comprises a second simulated lung; and
the simulating the asthmatic breathing pattern using the asthma simulation module of the patient simulator comprises simulating the asthmatic breathing pattern with at least one of the first simulated lung or the second simulated lung.

33. The method of claim 32, wherein the simulating the asthmatic breathing pattern using the asthma simulation module of the patient simulator comprises simulating the asthmatic breathing pattern with both of the first simulated lung and the second simulated lung.

34. The method of claim 33, wherein the simulating the asthmatic breathing pattern with both of the first simulated lung and the second simulated lung comprises simulating the asthmatic breathing pattern by independently controlling one or more parameters of the asthmatic breathing pattern for each of the first simulated lung and the second simulated lung.

35. The method of claim 33, wherein the simulating the asthmatic breathing pattern with both of the first simulated lung and the second simulated lung comprises simulating the asthmatic breathing pattern by jointly controlling one or more parameters of the asthmatic breathing pattern for both of the first simulated lung and the second simulated lung.

36. The method of claim 19, further comprising:
coupling an external ventilator to the patient simulator, the external ventilator configured to detect the asthmatic breathing pattern.
